(19) United States
(12) Patent Application Publication
(10) Pub. No.: US 2023/0010120 A1
(43) Pub. Date: Jan. 12, 2023

(54) WIND CHARGER

(71) Applicant: ROBERT MARTIN SCHWEITZER, Columbia, MD (US)

(72) Inventor: ROBERT MARTIN SCHWEITZER, Columbia, MD (US)

(21) Appl. No.: 17/854,160

(22) Filed: Jun. 30, 2022

Related U.S. Application Data
(60) Provisional application No. 63/259,309, filed on Jul. 7, 2021.

(51) Int. Cl. F03D 13/20; F03D 9/25

(52) U.S. Cl. CPC F03D 13/20; F03D 9/25

(57) ABSTRACT

Devices and methods for generating energy (e.g., electrical energy) from wind. A preferred form is directed to a wind charger that creates energy from wind to be directed to a source needing the created energy, e.g., one or more batteries. The batteries can be used to power any device including but not limited to devices in homes needing energy and/or devices that transport one or more persons over land, in the air or over water. Preferably, a mounting assembly optimally positions one or more elements generating electrical energy from wind relative to direction of wind to maximize the electrical energy generated by wind.

### RELATED APPLICATION

The subject patent application claims priority from U.S. Provisional Patent Application Ser. No. 63/259,309 filed on Jul. 7, 2021. The entire contents of U.S. Provisional Patent Application Ser. No. 63/259,309 are incorporated herein by reference.

### FIELD OF INVENTION

This invention pertains generally to devices and methods for generating energy (e.g., electrical energy) from wind. A preferred embodiment of the present invention is directed to a wind charger i.e., a device that generates useable energy from wind. Preferably, a preferred embodiment of the present invention creates electrical energy from wind with the electrical energy being supplied to a source needing the created electrical energy, e.g., one or more batteries. The batteries can be used to power any device including but not limited to devices in homes or other building structures needing energy and/or devices that transport one or more persons over land, in the air or over water. A preferred embodiment of the present invention includes a mounting assembly that optimally positions one or more elements generating electrical energy from wind relative to direction of wind to maximize the electrical energy generated by wind.

### BACKGROUND OF INVENTION

Devices and methods for creating useable energy from wind are known including devices used in electrical vehicles to provide electrical energy to one or more batteries used to power the vehicle. However, the energy generating element (e.g., fan or other element rotated by wind) is fixed in a particular position regardless of direction of wind. Accordingly, the energy generating element is not optimally positioned relative to direction of wind. Hence, such prior devices are not capable of maximizing the useable energy generated by wind.

Therefore, there exists an immediate need for a wind charger configured to move between numerous potential operating positions to an optimal position relative to direction of wind to maximize the useable energy created by the wind charger.

### OBJECTS AND SUMMARY OF THE INVENTION

An object of one or more preferred embodiments of the present invention is to provide novel and unobvious methods, apparatuses, and systems for optimally producing useable energy from wind.

Another object of a preferred embodiment of the present invention is to provide a wind charger (i.e., a device that generates useable energy from wind) that includes an energy generating element moveable between a plurality of operating positions to an optimal position based on direction of wind to maximize the useable energy created by the wind charger.

A further object of a preferred embodiment of the present invention is to provide a wind charger that can be used in a plurality of different environments to provide useable energy from wind including but not limited to a home or other building structure and/or a craft or vehicle (e.g., water, air and/or land craft or vehicle) for transporting one or more persons.

Still another object of a preferred embodiment of the present invention is to provide a mounting assembly for mounting an energy generating element (e.g., a fan or other element that moves/rotates in response to wind or airflow impacting the fan or other element) that allows the energy generating element to move about at least one axis (e.g., horizontal and/or vertical) to optimally position the energy generating element relative to direction of wind.

Yet another object of a preferred embodiment of the present invention is to provide a mounting assembly for mounting an energy generating element (e.g., a fan or other element that moves/rotates in response to wind or airflow impacting the fan or other element) wherein components of the mounting assembly move about at least two axes including a horizontal axis and a vertical axis to optimally position the energy generating element relative to direction of wind.

Yet still a further object of a preferred embodiment of the present invention is to provide a mounting assembly for an element generating useable energy from wind (e.g., a fan or other element that moves/rotates in response to wind or airflow impacting the fan or other element) wherein the mounting assembly includes one or more directional devices or members (e.g., directional air flaps) that automatically positions the element generating useable energy in an optimal position relative to direction of wind.

Another object of a preferred embodiment of the present invention is to provide a mounting assembly for an element generating useable energy from wind (e.g., a fan or other element that moves/rotates in response to wind or airflow impacting the fan or other element) wherein the mounting assembly automatically and continuously readjusts the position of the element generating useable energy based on changes in direction of wind to maintain the energy element in an optimal position.

A preferred embodiment of the present invention is directed to an apparatus for creating electrical energy from wind including a fan member, an output member having a first portion connected to the fan member so that the output member rotates with the fan member. The output member has a second portion connected to a generator for generating electrical energy from rotation of the fan member by wind. The apparatus further includes a mounting assembly for mounting the fan member in a predetermined area (e.g., a water, air and/or land craft or vehicle or a dwelling or other building structure). The mounting assembly is configured to move the fan member based on wind direction so that the fan member can assume a plurality of different positions to optimally orient the fan member relative to a plurality of different wind directions to maximize electrical energy generated by the apparatus from wind.

Another preferred embodiment of the present invention is directed to an apparatus for creating electrical energy from wind including a fixed frame member, at least one moveable frame member operably connected to the fixed frame member and moveable relative to the fixed frame member about one or more axes and an energy generating element or member operably connected to the at least one moveable member to optimally position the energy generating element relative to wind direction. The apparatus further includes an output member operably connected to the energy generating element member to move with the energy generating element or member. The output member is further operably connected to a generator for generating electrical energy from rotation of the energy generating element or member by wind.

A further preferred embodiment of the present invention is directed to a wind charger for charging or recharging one or more batteries by electrical energy created from wind including a fan member, an output member having a first portion connected to the fan member so that the output member rotates with rotation of the fan member. The output member has a second portion connected to a generator for generating electrical energy from rotation of the fan member by wind. The wind charger further includes a mounting assembly for mounting the fan member in an area adjacent one or more batteries to be charged or recharged. The mounting assembly is configured to move the fan member between operational positions to optimally position the fan member relative to wind direction to maximize electrical energy generated by the wind charger from wind.

The above objects of the invention and summaries describe preferred forms of the present invention and are not in any way to be construed as limiting the claimed invention to the preferred forms or any object recited above.

### BRIEF DESCRIPTION OF THE DRAWINGS

FIG. 1 is a schematic diagram of a preferred embodiment of the present invention.

FIG. 2 is a schematic diagram of two preferred moveable members of a preferred mounting assembly.

FIG. 3 is a schematic diagram of a portion of one moveable member of a preferred mounting assembly in which directional positioning members are mounted above and below a horizontal axis about which the corresponding moveable member freely rotates in either a clockwise or counterclockwise direction.

FIG. 4 is a schematic diagram of a portion of a preferred embodiment of the present invention including a preferred energy generating element connected to a generator by a shaft.

FIG. 5 is a perspective view of a preferred form of the present invention.

### DETAILED DESCRIPTION OF THE PREFERRED EMBODIMENTS OF THE INVENTION

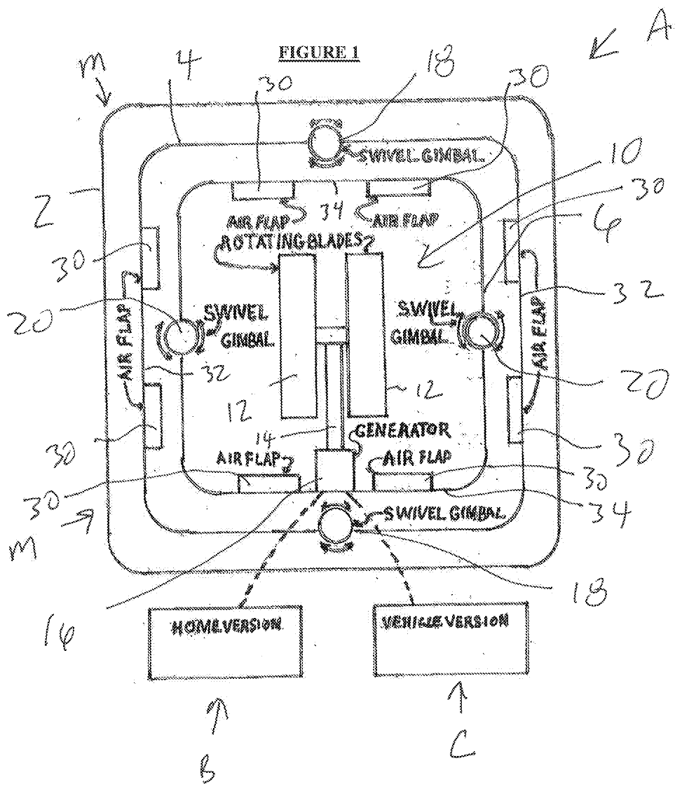

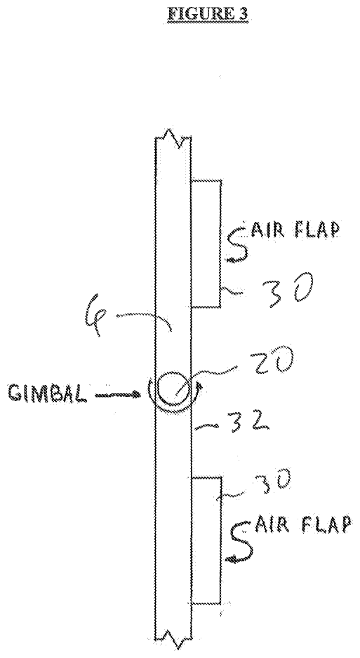

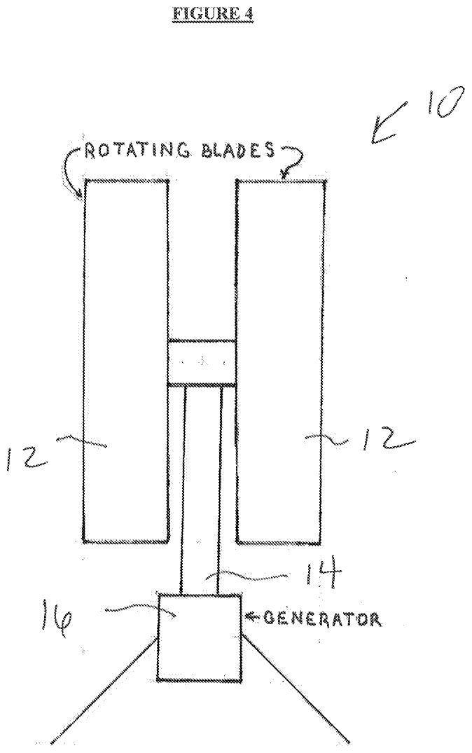

The preferred forms of the presented invention will now be described with reference to FIGS. 1-5. The appended claims are not limited to the preferred forms and no term and/or phrase used herein is to be given a meaning other than its ordinary meaning unless it is expressly stated otherwise.

The preferred forms of the present invention relate to enhanced methods, apparatuses and systems for generating useable energy (e.g., electrical energy) from wind. In a most preferred form, the present invention is directed to a wind charger that uses one or more fans or other energy generating elements that are rotated by wind. The one or more fans or other energy generating elements rotated by wind are operably connected to one or more output members that rotate with the corresponding fan or other energy generating element. The one or more output members are further connected to one or more generators to generate electrical energy from the rotation of the one or more output members caused at least in part by the corresponding fan or other energy generating element.

In a preferred form, the one or more output members are one or more shafts fixed to one or more fans or other energy generating elements rotated by wind. However, the output member is not limited to a shaft but rather can include any suitable member to connect one or more fans or other elements rotated by wind to a corresponding generator.

A preferred embodiment of the present invention includes a mounting assembly that is configured to automatically position the one or more fans or other energy generating elements rotated by wind in a plurality of different operating positions to optimally position the one or more fans or other elements relative to direction of wind. In a most preferred form, the mounting assembly that is configured to automatically and continuously readjust the position of the one or more fans or other energy generating elements based on changes in direction of wind.

A preferred mounting assembly includes at least one moveable member operably connected to the one or more fans or other energy generating elements wherein the at least one moveable member rotates about at least one axis (e.g., horizontal axis and/or vertical axis). In a most preferred form of the present invention, the mounting assembly includes an inner moveable frame member, an outer moveable frame member and a fixed frame assembly. Preferably, the inner moveable frame member is free to rotate in either direction (clockwise or counter clockwise) about a horizontal axis relative to the outer moveable frame member and the fixed frame assembly. The outer moveable frame member is free to rotate in either direction (clockwise or counter clockwise) about a vertical axis relative to the fixed frame member. The inner moveable frame member is connected to the outer moveable frame member so that inner moveable frame member rotates with the outer moveable frame member about the vertical axis while allowing the inner moveable frame member to freely rotate in either direction (clockwise or counter clockwise) about the horizontal axis relative to the outer moveable frame member.

Preferably, a fan or other energy generating element rotated by wind is directly connected to the inner moveable frame member such that the fan or other element is free to rotate about a longitudinal axis of the fan or other energy generating element rotated by wind relative to the inner moveable frame member but moveable with the inner moveable frame member as the inner moveable frame member rotates about the horizontal axis causing the fan or other energy generating element to rotate about the horizontal axis.

In a most preferred form of the present invention, the inner moveable frame member and/or the outer moveable frame member includes one or more directional or positioning members that optimally, continuously and automatically position the fan or other energy generating element relative to direction of wind.

Referring to FIGS. 1 to 5, a preferred wind charger or device A for generating electrical energy from wind will now be described. As illustrated in FIG. 1, device A can be connected, located or positioned adjacent or in a home B or other building structure or vehicle C (e.g., land, air or water transport device for transporting one or more persons). Structure B and vehicle C preferably include one or more batteries to be charged or recharged.

The device A includes a mounting assembly M that includes a fixed frame member 2 (i.e., a member that does not move when impacted by normal wind or airflow), a first moveable frame member 4 and a second moveable frame member 6. The fixed frame member 2 preferably surrounds both the first moveable frame member 4 and the second moveable frame member 6. The first moveable frame member 4 is disposed inside of a perimeter of fixed frame member 2 and surrounds second moveable frame member 6. Fixed frame member 2 may include feet 8 to position the device A in a desired position or location. However, other positioning elements (i.e., elements other than feet 8) may be used to position device A in a desired position or location. For example, fixed frame member 2 can be removably or permanently fixed or connected to any desired portion of a building structure or vehicle using any suitable fasteners or other connection means including but not limited to one or more clamps. By way of example only, fixed frame member 2 can be removably or permanently fixed to one or more elements in an engine housing portion of a vehicle. The term vehicle as used herein includes a vehicle which transports one or more persons over land, water or in the air. It is to be noted that device A is to be mounted in an area or location accessible to wind or airflow.

The device A includes one or more fans 10 each having one or more blades or fins 12 (e.g., one to four blades or fins) that air or wind strikes or impacts to rotate the one or more fans 10 about a longitudinal axis of a corresponding fan 10. Shaft 14 is fixed to fan 10 so that shaft 14 rotates with fan 10. It is to be noted that the term fan and fan member as used herein includes any device configured to be rotated by air flow or wind striking or otherwise impacting the fan or fan member.

Shaft 14 is further connected to generator 16. Generator 16 is configured to convert rotation of fan 10 and shaft 14 to electrical energy. Generator 16 in turn is connected to one or more batteries to provide electrical energy to the one or more batteries.

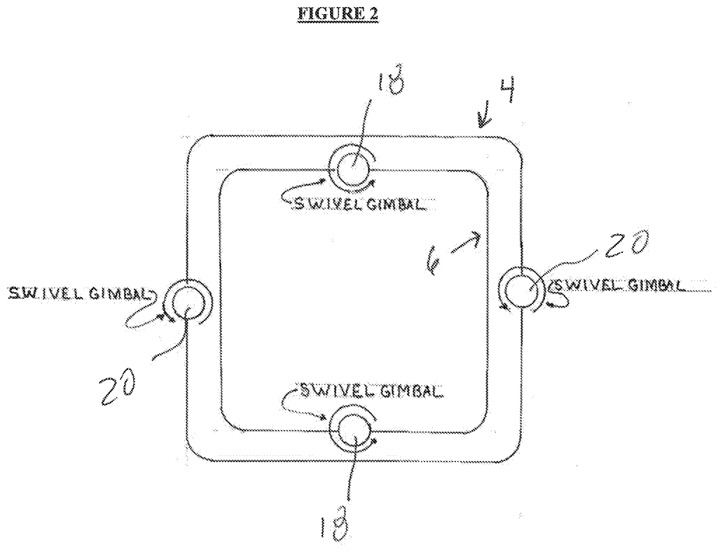

As schematically shown in FIGS. 1 and 2 by movement members 18, first moveable frame member 4 is mounted to freely rotate in either direction (clockwise or counter clockwise) about a first axis. Also, as schematically shown in FIG. 1 by movement members 20, second moveable frame member 6 is mounted to freely rotate in either direction (clockwise or counter clockwise) about a second axis perpendicular to the first axis providing a gimbal type mounting mechanism.

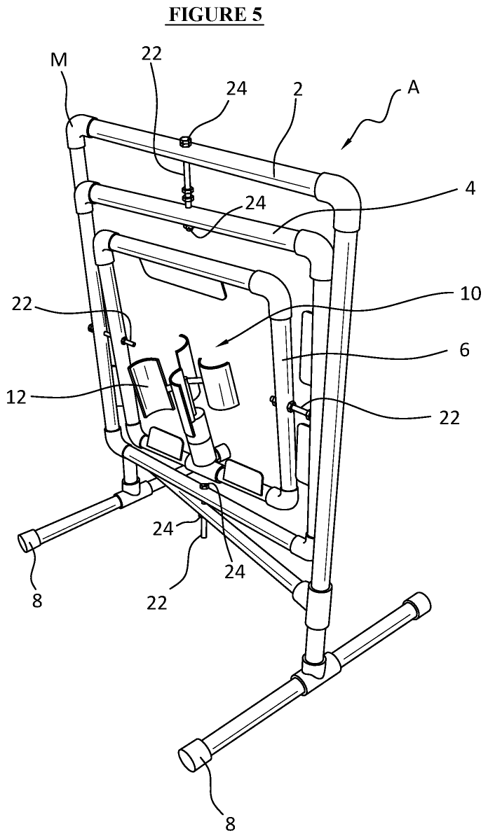

Referring to FIG. 5, movement members 18 and 20 include shafts or bolts 22 threaded at each end and fasteners (e.g., nuts) 24 connected to each of the two threaded ends of shafts or bolts 22 to operably connect first moveable member 4 to fixed frame member 2 and second moveable member 6 to first moveable member 4 such that the first moveable member 4 is free to rotate relative to the fixed frame member 2 about a vertical axis and the second moveable member 6 is free to rotate relative to the first moveable member 4 about a horizontal axis while causing the second moveable member 6 to move with the first moveable member about the vertical axis. Any other mounting arrangement can be used to provide or achieve the above-described movement of members 4 and 6. For example, bearings could be used to facilitate movement of members 4 and 6.

Preferably, first moveable frame member 4 is rotatably connected to fixed frame member 2 by two vertically extending shafts 22 and nuts 24 threaded on each end of shafts 22, one shaft being positioned in a central upper portion of mounting assembly M and extending through a corresponding portion of fixed frame member 2 and a corresponding portion of first moveable frame member 4 and the other shaft 22 being positioned being positioned in a central lower portion of mounting assembly M and extending through a corresponding portion of fixed frame member 2 and a corresponding portion of first moveable frame member 4. This mounting of first moveable frame member 4 operably connects first moveable frame member 4 to fixed frame member 2 to allow first moveable frame member 4 to freely rotate in either direction (clockwise or counter clockwise) about a vertical axis extending through upper and lower center portions of mounting assembly M and each of the upper and lower shafts 22 connecting member 4 to member 2.

As seen in FIG. 5, second moveable frame member 6 is rotatably connected to first moveable frame member 4 by two horizontally extending shafts 22 and nuts 24 threaded on each end of shafts 22, one shaft being positioned in a central left side portion of mounting assembly M and extending through a corresponding portion of first moveable frame member 4 and a corresponding portion of second moveable frame member 6 and the other shaft 22 being positioned being positioned in a central right side portion of mounting assembly M and extending through a corresponding portion of first moveable frame member 4 and a corresponding portion of second moveable frame member 6. This connection of the second moveable frame member 6 to the first moveable frame member 4 allows the second moveable frame member 6 to freely rotate in either direction (clockwise or counter clockwise) about a horizontal axis extending through a center left-side and right-side portions of first frame member 4 and each of the left and right horizontally extending shafts 22 connecting member 4 to member 6. Further, this connection causes second moveable frame member 6 to rotate with first moveable frame member 4 about the vertical axis extending through upper center portion and lower center portion of mounting assembly M and each of the upper and lower vertically extending shafts 22 connecting member 4 to member 2.

As seen in FIGS. 1, 3 and 5, one or more directional positioning members 30 are connected to first moveable frame member 4 and second moveable frame member 6. Preferably, the directional positioning members 30 are air flaps that automatically, continuously and optimally position the corresponding moveable frame member relative to wind direction. By way of example, FIG. 1 illustrates two spaced air flaps 30 connected to and extending inwardly from each of the two vertically extending sides 32 of first moveable frame member 4. Again, by way of example, FIG. 1 illustrates two spaced air flaps 30 connected to and extending inwardly from each of the two horizontally extending portions 34 of second moveable frame member 6.

Airflow impacting the air flaps 30 on vertically extending portions 32 of first moveable frame member 4 will automatically and continuously cause the first moveable frame member 4 to rotate in either direction (clockwise or counter clockwise) about the vertical axis extending through a center portion of mounting assembly M and each of the upper and lower shafts 22 connecting member 4 to member 2 so that the first moveable frame member 4 can automatically and continuously assume an optimal position relative to changes in wind direction.

Airflow impacting the air flaps 30 on horizontally extending portions 34 of second moveable frame member 6 will automatically and continuously cause the second moveable frame member 6 to rotate in either direction (clockwise or counter clockwise) about the horizontal axis extending through a center left and right side portions of first moveable member 4 and each of the left and right horizontally extending shafts 22 connecting member 4 to member 6 so that the second moveable frame member 6 and fan 10 can automatically and continuously assume an optimal position relative to wind direction. Notably, the operating positions of the first and second moveable members can be continuously and automatically varied/changed due to changes in wind direction.

A preferred method includes providing an energy generating element configured to generate energy from rotation or other movement of the energy generating element by wind or airflow. Operably connecting the energy generating element (e.g., fan or other element configured to rotate or otherwise move due to wind or airflow) to a generator for converting movement of the energy generating element into useable energy (e.g., electrical energy). Mounting the energy generating element so that the operational position of the energy generating element automatically and continuously adjusts due to changes in airflow or wind direction. Supplying the useable energy to one or more sources (e.g., one or more batteries) needing useable energy.

It should be noted that first moveable frame member 4 can be mounted to rotate about a horizontal axis. Similarly, second moveable frame member 6 can be mounted to rotate about a vertical axis. While members 2, 4 and 6 are illustrated as having a rectangular configuration, these members can have any other suitable configuration including but not limited to circular, oval and/or triangular configurations. The components of device A can be formed from any suitable material including but not limited to metal and plastic. Further, the particular application may dictate the material from which the components of device A are formed.

The forgoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. The claims are not limited to the preferred embodiments and have been written to preclude such a narrow construction using the principles of claim differentiation.

I claim:

1. An apparatus for creating electrical energy from wind, said apparatus comprising:
(a) a fan member, an output member having a first portion connected to said fan member so that said output member rotates with said fan member, said output member having a second portion connected to a generator for generating electrical energy from rotation of said fan member by wind; and,
(b) a mounting assembly for mounting said fan member in a predetermined area, said mounting assembly being configured to move said fan member based on wind direction so that said fan member can assume a plurality of different positions to optimally orient said fan member relative to a plurality of different wind directions to maximize electrical energy generated by said apparatus from wind.

2. The apparatus set forth in claim 1, wherein:
(a) said generator is connected to one or more vehicle batteries to supply electrical energy to the one or more vehicle batteries.

3. The apparatus as set forth in claim 1, wherein:
(a) said generator is connected to one or more batteries to charge or recharge the one or more batteries.

4. The apparatus as set forth in claim 1, wherein:
(a) said mounting assembly includes a first member operably connected to said fan member to move said fan member about a first axis.

5. The apparatus as set forth in claim 4, wherein:
(a) said first axis is an axis extending perpendicular to a longitudinal axis of said fan member.

6. The apparatus as set forth in claim 4, wherein:
(a) said first axis is a horizontally extending axis.

7. The apparatus as set forth in claim 6, wherein:
(a) said first member is configured to allow said fan member to rotate 360 degrees about said horizontally extending axis.

8. An apparatus for creating electrical energy from wind, said apparatus comprising:
(a) a fixed frame member;
(b) at least one moveable frame member operably connected to said fixed frame member and moveable relative to said fixed frame member about one or more axes;
(c) an energy generating member operably connected to the at least one moveable member to optimally position said energy generating member relative to wind direction; and,
(d) an output member operably connected to said energy generating member to move with said energy generating member, said output member further being operably connected to a generator for generating electrical energy from rotation of said energy generating member by wind.

9. The apparatus as set forth in claim 8, wherein said generator is connected to one or more batteries of a vehicle.

10. The apparatus as set forth in claim 8, wherein:
(a) said at least one moveable frame member includes a first moveable frame member operably connected to said fixed frame member to move relative to said fixed frame member about a vertical axis.

11. The apparatus as set forth in claim 10, wherein:
(a) said at least one moveable frame member includes a second moveable frame member operably connected to said first moveable frame member to allow said second moveable frame member to move relative to said first moveable frame member about a horizontal axis.

12. The apparatus as set forth in claim 11, wherein;
(a) said energy generating member is operably connected to said second moveable frame member so that said energy generating member can rotate about said horizontal axis while rotating relative to said second moveable frame member about a longitudinal axis of said energy generating member.

13. The apparatus as set forth in claim 12, wherein:
(a) the first moveable frame member surrounds the second moveable frame member.

14. The apparatus as set forth in claim 13, wherein:
(a) said energy generating member is disposed inside a perimeter of said second moveable frame member.

15. A wind charger for charging or recharging one or more batteries by electrical energy created from wind, said wind charger comprising:
(a) a fan member, an output member having a first portion connected to said fan member so that said output member rotates with rotation of said fan member, said output member having a second portion connected to a generator for generating electrical energy from rotation of said fan member by wind; and,
(b) a mounting assembly for mounting said fan member in an area adjacent one or more batteries to be charged or recharged, said mounting assembly being configured to move said fan member between operational positions to optimally position said fan member relative to wind direction to maximize electrical energy generated by said wind charger from wind.

16. The wind charger as set forth in claim 15, wherein:
(a) said mounting assembly includes at least one directional air flap configured to optimally position said fan member relative to wind direction to maximize electrical energy generated by said wind charger from wind.

17. The wind charger as set forth in claim 16, wherein:
(a) said mounting assembly includes a fixed frame member and a first moveable frame member configured to move relative to said fixed frame member about a horizontal axis, said first moveable member having a plurality of directional air flaps, said first moveable frame member having an upper horizontally extending member and a lower horizontally extending member, said upper horizontally extending member and said lower horizontally extending member each having at least one directional air flap.

18. The wind charger as set forth in claim 17, wherein:
(a) said mounting assembly further includes a second moveable frame member configured to move relative to said fixed frame member about a vertical axis, said second moveable frame member having a plurality of directional air flaps, said second moveable frame member having two spaced vertically extending members, each of said two spaced vertically extending members having at least one directional air flap.

19. The wind charge as set forth in claim 18, wherein:
(a) said second moveable frame member surrounds said first moveable frame member and is connected to said first moveable frame member such that said first moveable frame member rotates about the vertical axis with said second moveable frame member while said first moveable frame member is free to rotate about the horizontal axis relative to the second moveable frame member.

20. The wind charger as set forth in claim 19, wherein:
(a) said fan member is disposed inside an outer perimeter of said first moveable frame member.
